(19) United States
(12) Patent Application Publication
(10) Pub. No.: US 2016/0320833 A1
(43) Pub. Date: Nov. 3, 2016

(54) LOCATION-BASED SYSTEM FOR SHARING AUGMENTED REALITY CONTENT

(71) Applicant: Joseph Schuman, New York, NY (US)

(72) Inventor: Joseph Schuman, New York, NY (US)

(21) Appl. No.: 15/105,848

(22) PCT Filed: Dec. 18, 2014
(86) PCT No.: PCT/US14/71129

§ 371 Date: Jun. 17, 2016

Related U.S. Application Data
(60) Provisional application No. 61/917,704, filed on Dec. 18, 2013.
(60) Provisional application No. 61/917,718, filed on Dec. 18, 2013.

(51) Int. Cl. G06F 3/01; G06T 3/40

(52) U.S. Cl. CPC G06F 3/011; G06F 3/017; G06T 3/40

(57) ABSTRACT

A system for interaction of a plurality of users in an augmented reality environment is disclosed, and comprises an augmented reality server that comprises one or more processors, one or more non-transitory computer-readable memory devices, a user device module, an augmented reality content module, and a correlation module. The augmented reality server is configured to cause a common computer-generated element to be displayed to each user device of a plurality of user devices along with a physically-present element that is in proximity to each user device of the plurality of user devices.

### CROSS-REFERENCE TO RELATED APPLICATIONS

The present application claims the benefit of and priority to each of U.S. Provisional Patent Application No. 61/917,718, filed on Dec. 18, 2013, and U.S. Provisional Patent Application No. 61/917,704, filed on Dec. 18, 2013, the entire contents of each of which are incorporated by reference herein.

### FIELD

The present invention generally relates to augmented reality systems, program products, and methods of using the same that provide for the interaction of multiple users across an augmented reality environment.

### BACKGROUND

Augmented reality systems provide a user with a view of a real-world space supplemented with computer-generated content that can be overlaid upon and/or dispersed with real-world elements. The view of the real-world space can be provided, for example, through a direct line of sight to a user (such as through a transparent portion of a wearable electronic device) or through a displayed image of the real-world environment.

In conventional augmented reality systems, users are sometimes provided with the option to view computer-generated content associated with remote elements, such as persons or objects located outside of their proximate physical location. For example, U.S. Patent Application Publication Number 2013/0117377 describes various augmented reality and virtual reality configurations that include the interaction of a user with an avatar of a remotely-located other user.

### SUMMARY

In an exemplary embodiment of the present invention, a system for interaction of a plurality of users in an augmented reality environment is disclosed, and comprises an augmented reality server that comprises one or more processors, one or more non-transitory computer-readable memory devices, a user device module, an augmented reality content module, and a correlation module. The one or more non-transitory computer-readable memory devices are electronically coupled with the one or more processors to implement one or more instructions. The user device module is electronically coupled with the one or more non-transitory computer-readable memory devices and configured to receive data associated with physical inputs from one or more user devices of a plurality of user devices that are electronically coupled with the augmented reality server, and each user device of the plurality of user devices is located in physical proximity to one another. The augmented reality content module is electronically coupled with the one or more non-transitory computer-readable memory devices and is configured to transmit data associated with computer-generated elements for display on the plurality of user devices. The correlation module is configured to match the data associated with physical inputs from the one or more user devices of the plurality of user devices with the data associated with computer-generated elements for display on the one or more user devices of the plurality of user devices so that the augmented reality server causes a common computer-generated element to be displayed to each user device of the plurality of user devices along with a physically-present element that is in proximity to each user device of the plurality of user devices.

In embodiments, the augmented reality server is configured to modify data associated with the common computer-generated element to be displayed in a unique manner on at least one user device of the plurality of user devices.

In embodiments, the data associated with the common computer-generated element is modified to be displayed in a different size on the at least one user device of the plurality of user devices.

In embodiments, the data associated with the common computer-generated element is modified based upon data associated with a physical location of the at least one user device of the plurality of user devices.

In embodiments, the data associated with physical inputs from the one or more user devices of the plurality of user devices includes data associated with physical gestures.

In embodiments, the physical gestures are performed by an operator associated with the one or more user devices of the plurality of user devices.

In embodiments, the data associated with one or more physical inputs from the one or more user devices includes data associated with an environmental condition.

In embodiments, the data associated with computer-generated elements is provided by an operator associated with a user device of the plurality of user devices.

According to an exemplary embodiment of the present invention, a method is disclosed, and comprises: (a) retrieving, by an augmented reality server having one or more processors configured to read one or more instructions stored on one or more non-transitory computer-readable memory devices, data associated with physical inputs from one or more user devices of a plurality of user devices electronically coupled with the augmented reality server and in physical proximity to one another; (b) matching, by a correlation module of the augmented reality server, the data associated with physical inputs from the one or more user devices of the plurality of user devices with data associated with augmented reality content on the augmented reality server; and (c) transmitting for display, by an augmented reality content module of the augmented reality server, the data associated with augmented reality content to the plurality of user devices so that the plurality of user devices can display a common computer-generated element along with a physically-present element that is in proximity to the plurality of user devices.

In embodiments, the augmented reality server modifies the data associated with augmented reality content to be displayed in a unique manner on at least one user device of the plurality of user devices.

In embodiments, the augmented reality server modifies the data associated with augmented reality content to be displayed in a different size on the at least one user device of the plurality of user devices.

In embodiments, the augmented reality server modifies the data associated with augmented reality content based upon data associated with a physical location of the at least one user device of the plurality of user devices.

In embodiments, the data associated with physical inputs from the one or more user devices of the plurality of user devices includes data associated with physical gestures.

In embodiments, the physical gestures are performed by an operator associated with the one or more user devices.

In embodiments, the data associated physical inputs from the one or more user devices includes data associated with an environmental condition.

In embodiments, the data associated with augmented reality content is provided by an operator associated with a user device of the plurality of user devices.

### BRIEF DESCRIPTION OF THE DRAWINGS

Various exemplary embodiments of this invention will be described in detail, with reference to the following figures, wherein:

FIG. 1 is a schematic diagram of an augmented reality system according to an exemplary embodiment of the present invention;

FIG. 2A is a schematic diagram of an augmented reality server of the augmented reality system of FIG. 1;

FIG. 2B is a schematic flow chart of one configuration of the augmented reality system of FIG. 1;

FIG. 2C is a schematic flow chart of another configuration of the augmented reality system of FIG. 1;

FIG. 3A is a first sequential view of an interaction between two users engaged in an augmented reality environment across the augmented reality system of FIG. 1; and

FIG. 3B is a second sequential view of an interaction between two users engaged in an augmented reality environment across the augmented reality system of FIG. 1.

### DETAILED DESCRIPTION

The present invention generally relates to augmented reality systems, program products, and methods of using the same that provide for the interaction of multiple users in physical proximity to one another across an augmented reality environment.

As described herein, “augmented reality content” can refer to computer-generated elements that are overlaid with and/or interspersed with real-world elements to form an augmented reality environment.

As described herein, “augmented reality data” and “data associated with augmented reality content” refers to electronic data associated with augmented reality content. Such augmented reality data can also include data associated with computer-generated sounds or other computer-controlled actions, such as motion or shaking in the context of haptic feedback.

According to exemplary embodiments described herein, augmented reality-based systems, program products, and associated methods are provided so that multiple users can enhance interpersonal interactions through the use of augmented reality content. In this regard, the multiple users are located in physical proximity to one another in order to take full advantage of the augmented reality experience. Such augmented reality-based systems, program products, and associated methods are provided to users, for example, for entertainment, distraction, escapism, the enhancement of social interaction (such as conversation, camaraderie, or storytelling), to foster creativity, for thought experiments, and/or to provide a measure of theoretical modeling with respect to real-world objects.

As described herein, interactions between multiple users in an augmented reality environment can occur in a local fashion through a direct connection of multiple user devices (e.g., across a mesh network), and/or can occur in a networked fashion, for example through a social media program run on multiple user devices.

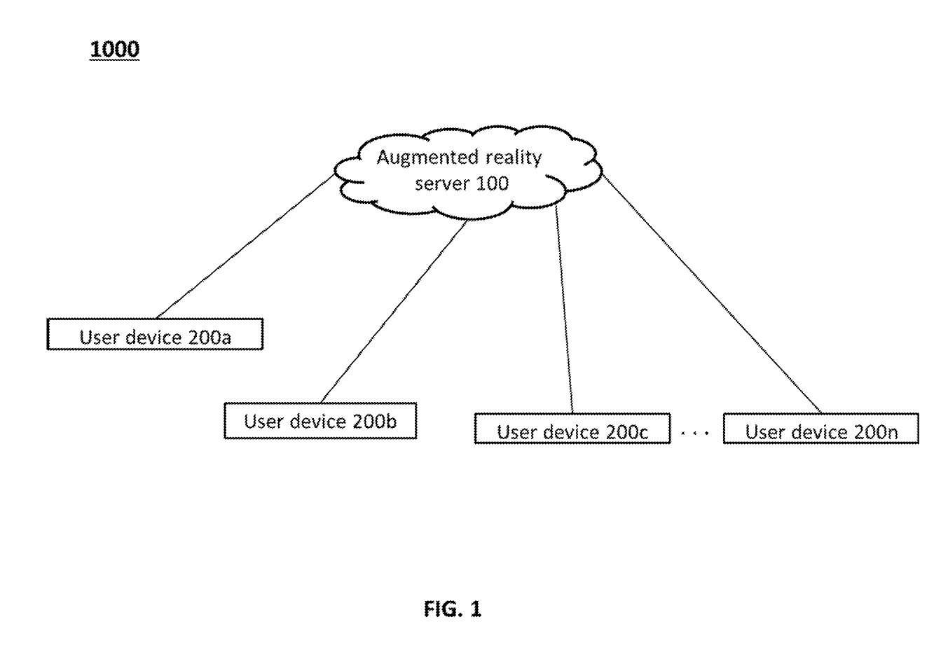

Turning to FIG. 1, an exemplary embodiment of an augmented reality system is generally designated 1000. Augmented reality system 1000 includes an augmented reality server 100 that communicates augmented reality data to a plurality of user devices 200a, 200b, 200c, 200n that are electronically coupled with an augmented reality server 100 across one or more electronic data networks. Such data networks can include wired electronic data connections (such as cable or fiber optic lines), wireless data electronic connections (such as Wi-Fi, Bluetooth, NFC, or Z-wave connections), and/or combinations thereof (such as in mesh networks). It will be understood that augmented reality system 1000 can include a different plurality of user devices than illustrated.

As described herein, user devices 200a, 200b, 200c . . . 200n are electronic devices that are electronically coupleable with the augmented reality server 100 to receive and/or transmit augmented reality data to the augmented reality server 100. Accordingly, user devices 200a, 200b, 200c . . . 200n include a visual display element that can provide a user with a view of a real-world environment supplemented with augmented reality content. User devices 200a, 200b, 200c . . . 200n also include a location-sensing component, such as a GPS antenna or cellular network antenna, for communicating a position of a respective user device 200a, 200b, 200c . . . 200n with respect to a map system or point of reference. User devices 200a, 200b, 200c . . . 200n also incorporate one or more input devices for receiving physical input commands, for example, a motion-tracking sensor (such as an eye-tracking sensor) for responding to gestural cues, a microphone for receiving voice commands, and/or tactile inputs such as buttons or other physical controls. One such user device known in the art is sold under the name Google Glass by Google Inc. of Mountain View, Calif. In an example user device, multiple visual display elements can be provided, e.g., at least one visual display element directed at each of a user's eyes.

It will be understood that user devices described herein can be configured to record real-world and/or augmented reality content that is displayed, for example, for later viewing and/or editing.

In order to provide a substantially seamless simultaneous display of real-world and computer-generated elements, a respective user device can employ computer vision techniques such as feature extraction and motion tracking to correctly orient computer-generated elements with respect to a user's perspective in a three-dimensional space and to take into account various ancillary factors (e.g., local visibility conditions) that cause image distortion.

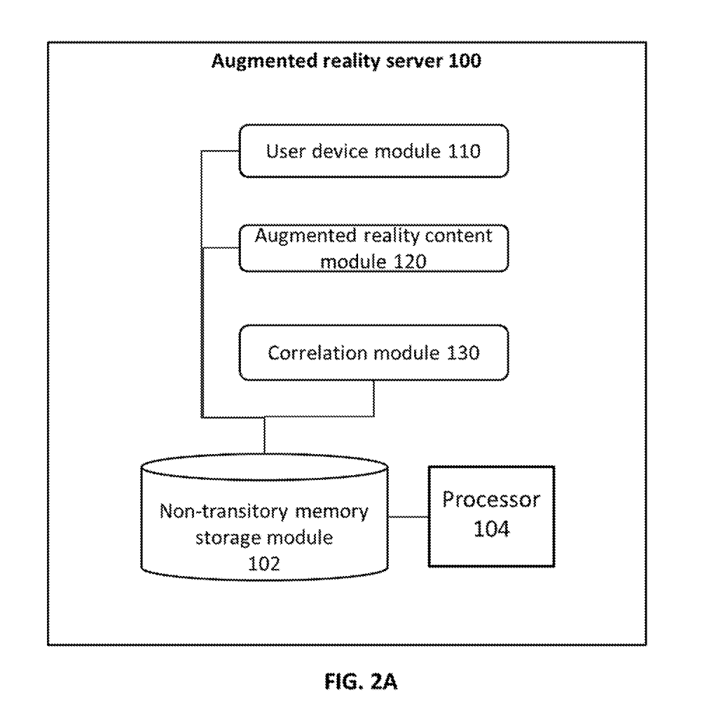

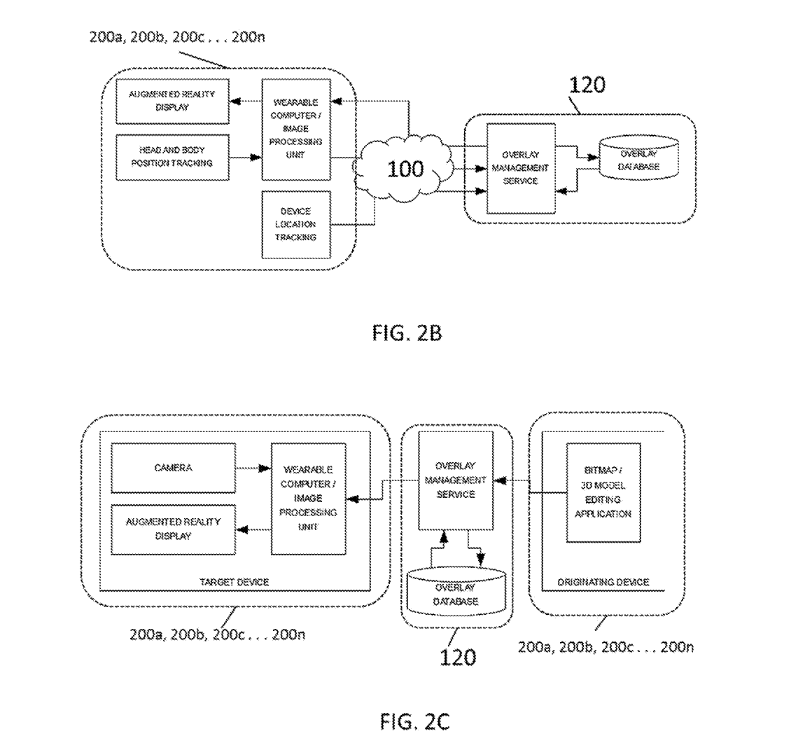

Referring additionally to FIG. 2A, a schematic diagram of augmented reality server 100 is illustrated.

Augmented reality server 100 is configured to receive, store, manipulate and/or transmit for display and/or projection electronic data associated with augmented reality content transmitted across augmented reality system 1000. In this regard, augmented reality server 100 is formed of one or more computer systems that can store data on one or more non-transitory computer readable memory storage devices 102 with one or more processors 104 configured to implement machine-readable instructions associated with augmented reality content and stored on the one or more non-transitory computer readable memory storage devices 102.

Accordingly, augmented reality server 100 can include one or more modules dedicated toward performing tasks across augmented reality system 1000 relating to the receipt, storage, manipulation and/or transmission for display and/or projection electronic data associated with augmented reality content. Such modules can be computer hardware elements and/or associated elements of machine-readable instructions directed toward one or more actions across augmented reality system 1000.

As shown, augmented reality server 100 includes a user device module 110 that handles data from one or more of user devices 200a, 200b, 200c . . . 200n. Such data received from the one or more user devices 200a, 200b, 200c . . . 200n can be in the form of physical input data detected by one or more sensing devices of the respective user devices 200a, 200b, 200c . . . 200n. For example, user device module 110 can receive data related to motion gestures initiated by an operator of a respective user device 200a, 200b, 200c . . . 200n and/or by other objects (e.g., persons who are not the operator of the respective user device and/or inanimate objects or environmental cues detected by the respective user device). Such gestures can be, for example, eye movements (such as a twitch, wink, or glance), a hand motion (such as a snapping of fingers), an arm motion (such as a wave or fist pump), a head motion (such a nod or tilt), or other body motions or gestural signifiers, as described further herein. Other data received by the user device module 110 can include, for example, voice commands from a user other person and/or other audio-based commands.

User device module 110 can also receive data that is passively generated by one or more of user devices 200a, 200b, 200c . . . 200n, for example, data associated with a location generated by a location-sensing device of a respective user device 200a, 200b, 200c . . . 200n.

Augmented reality server 100 also includes an augmented reality content module 120 that handles augmented reality content data for transmission to one or more of user devices 200a, 200b, 200c . . . 200n. In this regard, augmented reality content module 120 is configured to provide an augmented reality content management service that receives, validates, stores, and/or publishes augmented reality content and associated metadata to one or more of user devices 200a, 200b, 200c . . . 200n. Accordingly, it will be understood that augmented reality content module 120 can be configured to encode augmented reality data in a format suitable for display on the plurality of user devices 200a, 200b, 200c . . . 200n.

As described above, augmented reality content data is associated with computer-generated elements that can be overlaid and/or interspersed with real-world elements viewed through the respective user devices 200a, 200b, 200c . . . 200n. Such computer-generated elements can include, for example, still images, animations, video clips, icons, text, and/or graphics. For example, augmented reality content can include computer-generated elements that are overlaid as fixed or floating elements overlaying a portion of a user's real-world appearance, such as masks, clothing, accessories, or other objects. Referring additionally to FIG. 2B, one possible configuration of augmented reality system 1000 is illustrated for providing augmented reality content to user devices 200a, 200b, 200c . . . 200n.

For example, a user can elect for augmented reality content module 120 to display a mask and/or associated accessories upon the real-world instance of his or her body to other users participating in augmented reality system 1000. Such masks and/or associated accessories can be whimsical elements (for example, characters or elements from a film franchise) or can be more realistic elements, such as a computer-generated approximation of the user's actual likeness) that are tracked to move and respond to a user's movements, expressions, and/or other behaviors. In the latter instance, the computer-generated approximation of the user's actual likeness can be animated or otherwise controlled to perform visually-enticing actions, for example, fly or glide in lieu of walk.

As an additional example, augmented reality content can include computer-generated elements that supplant a user's real-world appearance, e.g., to give the appearance of supernatural actions such as flying.

Computer-generated augmented reality content described herein can be displayed singly and/or in combination with respect to a user, for example, a computer-generated mask fixed to a user's face and having a separate computer-generated hat displayed atop the mask.

Additionally, computer-generated augmented reality content described herein can emulate a user's movements, body language, and/or facial expressions, for example, through the use of facial and/or object recognition techniques. Such techniques can be used to map and/or track portions of a user's body through a respective user device.

Computer-generated augmented reality content described herein can be reconfigurable by augmented reality server 100 to be displayed proportionally to a real-world or computer-generated element upon which it is fixed or tracked. For example, clothing can be sized, filled, ruffled, stretched, etc., based upon the size and/or actions of a real-world user or computer-generated avatar to which is fixed or tracked.

Data associated with augmented reality content can be generated by an owner and/or operator of augmented reality system 1000 or portions thereof, or can be created by a third party, such as a commercial creator of electronic content. Users can be presented with the option to access data associated with selected augmented reality content through an interface such as an online or in-program store, for example, so that users can purchase or obtain licenses for the use of selected augmented reality content. Users can also be presented with the option to create augmented reality content of their own design for distribution across augmented reality system 1000. In this regard, data associated with augmented reality content can be fully customizable, e.g., selectable, by a user so that a user can choose to display augmented reality content, for example, of various sizes, colors, heights, builds, and/or expressions. For example, a user can overlay selected real-world objects such as persons with masks or costumes. Such augmented reality content can be shared with other users participating in augmented reality system 1000 as augmented reality content kits, templates, themes, and/or packages that are downloadable for viewing different augmented reality environments. Referring additionally to FIG. 2C, one possible configuration of augmented reality server 1000 to implement the above-described augmented reality content sharing is illustrated.

Augmented reality server 100 also includes a correlation module 130 that correlates one or more data sets associated with data from a respective user device 200a, 200b, 200c . . . 200n with one or more data sets stored on the augmented reality content module 120. In this regard, a physical input to a respective user device 200a, 200b, 200c . . . 200n causes a predetermined transmission of data from the augmented reality content module 120 to cause a corresponding change in the augmented reality environment displayed on the respective user device 200a, 200b, 200c . . . 200n. In this regard, correlation module 130 can employ one or more of facial recognition, object recognition, and/or real-time motion analysis to match data associated with inputs from user devices 200a, 200b, 200c . . . 200n with corresponding data on the augmented reality content module 120.

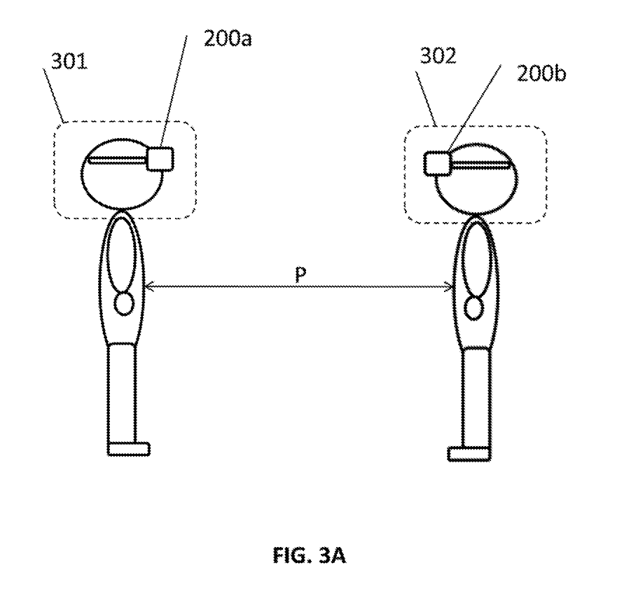

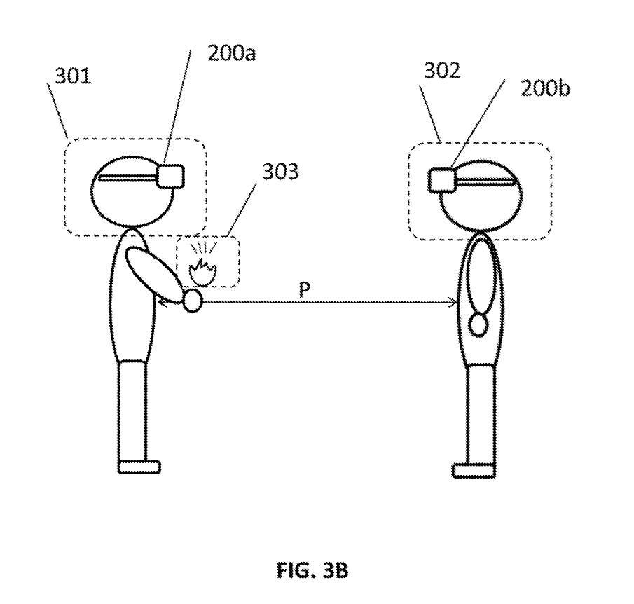

Still referring to FIG. 1 and FIG. 2A, and turning additionally to FIG. 3A, an example of a social interaction of two users across augmented reality system 1000 is illustrated. As shown, a user associated with a user device 200a is located a distance P in physical proximity with another user associated with user device 200b. The users associated with user devices 200a and 200b thus see each other in an augmented reality environment, which can include augmented reality elements 301, 302 as shown. Referring additionally to FIG. 3B, the user associated with user device 200b can provide a physical input to user device 200b, for example, by snapping his or her fingers, which can be detected by one or more sensors of the user device and transmitted as input data to the user device module 110 of augmented reality server 100. The correlation module 130 of augmented reality server 100 can in turn associate this input data with corresponding data from the augmented reality content module 120 for transmission to the respective user device. In the present example, the input data associated with the snapping of the user's figures can correspond to data associated with an augmented reality element 303, for example, the visual image of an animated fireball emanating from the user's hands. Such an effect would be visible to another user associated with a different user device of the plurality of user devices 200a, 200b, 200c . . . 200n that is in physical proximity with the first user.

In this regard, augmented reality server 100 can modify (e.g., scale) data associated with an augmented reality element that is transmitted for display on a user device based on a known location of the user device (e.g., from a location sensing device of the user device) relative to an intended position of the augmented reality element within an augmented reality environment. Accordingly, an augmented reality element can appear, for example, larger, smaller, brighter, or duller based on a detected proximity of the user device to the augmented reality element.

In another example, animations, actions, and/or transformations of computer-generated elements can be user-defined or system-defined to display on a single user's device. In this regard, such animations, actions, and/or transformations can be seen according to a single user's preferences, but are separate from the data associated with the computer-generated elements themselves, and may not be seen by other users of augmented reality system 1000. Such animations, actions, and/or transformations can include, for example, cinematic special effects (such as shaders, slow-motion animation, dolly zoom, match moving, miniaturization or scale effects, morphing, motion control, or stop motion), the transformation of computer-generated objects from one to another (for example, a glass of water to a glass of wine), the changing display of a computer-generated object in response to another user's action (such as disappearance of a computer-generated element upon exiting a room), the computer-generated obscuring (e.g. “cloaking”) of a user's real-world appearance and the substantially simultaneous action of his or her computer-generated counterpart avatar (such as giving the illusion of a user walking across an environment while he or she remains substantially stationary), and/or the supplantation of a real-world element with a similarly-appearing computer-generated element and animation thereof (such as overlaying the computer-generated image of a burning table over the real-world instance of a burning table).

As another example, a plurality of users wearing user devices 200a, 200b, 200c as shown can be assembled at a common physical location (e.g., within the same room or space) so that they can witness an ongoing live event, such as a theater performance. In this regard, augmented reality content can be provided to user devices 200a, 200b, 200c, as shown, that is overlaid upon and/or interspersed with the users' view of the live event. Accordingly, a live event such as a theater performance can be supplemented with augmented reality content, for example, to enhance a live performance by providing cinematic-quality augmented reality content to a plurality of assembled users having associated user devices. In this regard, a performance by physical actors could be supplemented by augmented reality content at the behest of a content manager, such as a director or choreographer (for example, so that a computer-generated explosion is caused to be displayed on the user devices in coordination with a jumping action by a physical actor). In such an example, the respective user devices of the assembled users can be more conducive to a non-wearable electronic device, such as a seat-mounted device having a display as are conventional in passenger aircraft and theaters (for example, a seat-mounted device that can project onto the eyes of a viewer in the seat).

In this regard, multiple users within physical proximity of one another can experience enhanced social encounters through the display of user-selected and/or customizable augmented reality content. The physical proximity of the multiple users also affords substance to the user experience because the provided content augments a live, physically present individual (as opposed to the passive, cartoon-esque qualities provided in the context of a virtual world encounter). Such an environment provides numerous possibilities for personalization and storytelling that would not be possible in social encounters limited to a real-world physical environment.

While augmented reality system 1000 has been described herein as configured accommodating multiple users each having associated user devices, it will be understood that a single user having an associated user device will be able to view a surrounded augmented reality environment. Further, the single user can be able to interact with and view augmented reality content associated with other nearby users that lack an associated user device, for example, through facial and/or object recognition functionalities of the user device worn by the single user.

In other examples, augmented reality system 1000 can be integrated with third-party hardware and/or software so that augmented reality content available for use on augmented reality system 1000 can be made available, for example, in commercial advertising contexts and social media contexts.

In one example, augmented reality content can be distributed from augmented reality server 100 to a smart television, electronic billboard, or other suitable networked advertising device in proximity to a user device associated with augmented reality system 1000. In this regard, computer-generated masks, avatars, and/or accessories can be overlaid upon and/or interspersed with aspects of a commercial medium (such as computer-generated avatars of users and other known individuals being substituted for actors in a soft drink commercial) to enhance the marketability of products and services.

In another example, a social media network can use computer-generated elements from augmented reality server 1000, for example, to display information in an augmented-reality fashion that is typically displayed on an external display screen. For example, a floating “YES” or “NO” near a real-world user or associated computer-generated avatar can indicate that an individual may wish or not wish to be approached (such as in a professional or dating context). Such an indicator can vary based upon one or more factors, for example, time of day, day of the week, location, the user's predefined schedule, the relation of the user to the viewed person (e.g., a detected match on one or more dating social networks or a mutual connection on a social media network), the gender of the viewed individual, and/or the age of the viewed individual. In another example, other individuals associated with a user's professional contacts may be enhanced with a unique computer-generated signifier, for example, a suit of clothing or a floating briefcase.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A system for interaction of a plurality of users in an augmented reality environment comprising:
an augmented reality server that comprises:
one or more processors;
one or more non-transitory computer-readable memory devices electronically coupled with the one or more processors to implement one or more instructions;
a user device module electronically coupled with the one or more non-transitory computer-readable memory devices and configured to receive data associated with physical inputs from one or more user devices of a plurality of user devices that are electronically coupled with the augmented reality server, each user device of the plurality of user devices located in physical proximity to one another;
an augmented reality content module electronically coupled with the one or more non-transitory computer-readable memory devices and configured to transmit data associated with computer-generated elements for display on the plurality of user devices;
a correlation module configured to match the data associated with physical inputs from the one or more user devices of the plurality of user devices with the data associated with computer-generated elements for display on the one or more user devices of the plurality of user devices so that the augmented reality server causes a common computer-generated element to be displayed to each user device of the plurality of user devices along with a physically-present element that is in proximity to each user device of the plurality of user devices.

2. The system of claim 1, wherein the augmented reality server is configured to modify data associated with the common computer-generated element to be displayed in a unique manner on at least one user device of the plurality of user devices.

3. The system of claim 2, wherein the data associated with the common computer-generated element is modified to be displayed in a different size on the at least one user device of the plurality of user devices.

4. The system of claim 2, wherein the data associated with the common computer-generated element is modified based upon data associated with a physical location of the at least one user device of the plurality of user devices.

5. The system of claim 1, wherein the data associated with physical inputs from the one or more user devices of the plurality of user devices includes data associated with physical gestures.

6. The system of claim 5, wherein the physical gestures are performed by an operator associated with the one or more user devices of the plurality of user devices.

7. The system of claim 1, wherein the data associated with one or more physical inputs from the one or more user devices includes data associated with an environmental condition.

8. The system of claim 1, wherein the data associated with computer-generated elements is provided by an operator associated with a user device of the plurality of user devices.

9. A method, comprising:
(a) retrieving, by an augmented reality server having one or more processors configured to read one or more instructions stored on one or more non-transitory computer-readable memory devices, data associated with physical inputs from one or more user devices of a plurality of user devices electronically coupled with the augmented reality server and in physical proximity to one another;
(b) matching, by a correlation module of the augmented reality server, the data associated with physical inputs from the one or more user devices of the plurality of user devices with data associated with augmented reality content on the augmented reality server; and
(c) transmitting for display, by an augmented reality content module of the augmented reality server, the data associated with augmented reality content to the plurality of user devices so that the plurality of user devices can display a common computer-generated element along with a physically-present element that is in proximity to the plurality of user devices.

10. The method of claim 9, wherein the augmented reality server modifies the data associated with augmented reality content to be displayed in a unique manner on at least one user device of the plurality of user devices.

11. The method of claim 10, wherein the augmented reality server modifies the data associated with augmented reality content to be displayed in a different size on the at least one user device of the plurality of user devices.

12. The method of claim 10, wherein the augmented reality server modifies the data associated with augmented reality content based upon data associated with a physical location of the at least one user device of the plurality of user devices.

13. The method of claim 9, wherein the data associated with physical inputs from the one or more user devices of the plurality of user devices includes data associated with physical gestures.

14. The method of claim 13, wherein the physical gestures are performed by an operator associated with the one or more user devices.

15. The method of claim 9, wherein the data associated physical inputs from the one or more user devices includes data associated with an environmental condition.

16. The method of claim 15, wherein the data associated with augmented reality content is provided by an operator associated with a user device of the plurality of user devices.
